(19) United States
(12) Patent Application Publication
(10) Pub. No.: US 2026/0142679 A1
(43) Pub. Date: May 21, 2026

(54) CARRIER POWER BOOST BY DYNAMIC LOGICAL SECTORIZATION

(71) Applicant: DISH Wireless L.L.C., Englewood, CO (US)

(72) Inventor: Karupaiah Rajendran, Sachse, TX (US)

(21) Appl. No.: 18/949,333

(22) Filed: Nov. 15, 2024

(51) Int. Cl. H04B 1/00; H04B 1/40; H04W 52/34; H04W 88/08

(52) U.S. Cl. CPC H04B 1/0067; H04B 1/40; H04W 52/343; H04W 88/08

(57) ABSTRACT

Technologies for dynamically reconfiguring a radio unit (RU) coupled to a cellular site of a cellular network are described. An RU is initially deployed with a default configuration having a plurality of radio frequency (RF) paths coupling the RU to a multi-port antenna that is serving a particular sector of a cell. Upon detecting increased demand for capacity within the particular sector, the RU is reconfigured by splitting the RU into a plurality of logical sub-sectors, each logical sub-sector of the RU having a respective subset of the plurality of RF paths coupled to a respective subset of ports of the multi-port antenna. A default configuration of 4T4R can be transformed into two 2T2R logical sub-sectors. A default configuration of 8T8R can be transformed into four 2T2R logical sub-sectors, or, two 4T4R logical sub-sectors, or, two 2T2R and one 4T4R logical sub-sector.

### BACKGROUND

Coverage and capacity are two important considerations for a wireless network. Coverage refers to a geographic footprint of a base station with one or more antennas. Total coverage of a base station can be divided into multiple sectors being served by respective antennas serving corresponding sub-regions within a bigger geographical area. Capacity refers to a number of users who can use various wireless services simultaneously in one place, and in what manner and at what rate the users are using bandwidth that the base station can support at an acceptable quality for various services that the users consume using their respective equipment.

Advanced 5G wireless networks, such as 5G New Radio (NR) cellular networks, have the promise to provide higher throughput, lower latency, and higher availability compared with previous global wireless standards. However, some default hardware configuration in a 5G cellular network cannot be scaled easily without deploying new hardware infrastructure, such as installing new antennas and related components, which may incur additional cost or cause interruption in user experience.

### BRIEF DESCRIPTION OF THE DRAWINGS

The present disclosure is illustrated by way of example, and not by way of limitation, in the figures of the accompanying drawings.

FIG. 1A is a block diagram of a system implementing smart dynamic reconfiguration of a radio unit (RU) in a cellular network according to at least one embodiment of the present disclosure.

FIG. 1B is high-level architecture 100B that is specific to sectorization management, according to a specific embodiment of the present disclosure.

FIG. 2 illustrates a multi-sector base station’s physical structure, according to according to a specific embodiment of the present disclosure.

FIG. 3 is a Table showing list of parameters of a default configuration and various other reconfigurations of an RU, according to a specific embodiment of the present disclosure.

FIG. 4 is an illustration of a 4T4R one-sector hardware, according to an embodiment of the present disclosure.

FIG. 5 is a Table showing parameters of a truncated set of configurations for hardware serving a sector in the 4T4R mode, according to a specific embodiment of the present disclosure.

FIG. 6 is an illustration of how the same 4T4R one-sector hardware is reconfigured into two 2T2R sub-sectors, according to an embodiment of the present disclosure.

FIG. 7 is a Table showing parameters a truncated set of configurations for a hardware serving a sector that is logically subdivided into two 2T2R sub-sectors, according to a specific embodiment of the present disclosure.

FIG. 8 is a flow diagram of an example method of a dynamic reconfiguration of an RU, according to a specific embodiment of the present disclosure.

### DETAILED DESCRIPTION

Technologies for adapting split sector configuration to increase power in existing radio frequency (RF) communication paths without adding additional hardware in a telecommunications network, such as a cellular network (e.g., 5G wireless network) are described. The scope of this disclosure is not limited to 5G network though, and previous generations of networks (such as, 4G, LTE) as well as upcoming future generations of networks (such as, 6G and 7G) are also encompassed by this disclosure. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The existing wireless infrastructure already deployed in a premise may prove to be inadequate when user capacity in the premise increases in terms of number of user equipment (UE) being simultaneously used in the premise. As a non-limiting example, consider a stadium that may have been built with an existing wireless infrastructure to serve ‘x’ number of UEs, used for mostly voice calls. But eventually capacity of the stadium multiplies, e.g., at certain times, ‘2x’ or more number of UEs are being used in the stadium, and many of the UEs are using high-bandwidth applications, such as video uploads of the event happening at the stadium, instead of making voice calls. This may impact quality of service, as evidenced by some critical performance metrics, such as the Maximum Allowable Path Loss (MAPL), being negatively impacted, because of increased demand for capacity (capacity overload). MAPL represents the maximum amount of attenuation (signal loss) that a radio signal can experience during transmission while still maintaining an acceptable level of signal quality for a specific data rate need. One solution to maintain an acceptable MAPL is to deploy new base stations with new antennas powered by new power sources. However, scaling the hardware infrastructure is not an instantaneous solution. It is not only costly, but also involves downtime for the services during new hardware deployment.

Another issue is evolving services available for the users. A UE currently using a particular service (such as a 5G) may want to also use an additional service (such as Cellular Internet of Things, CIoT) that the cellular service provider has started to support. The additional service may cause a certain sector of a cell to experience capacity overload. In an example situation, a big parking lot may have a kiosk at one corner of the parking lot which is capable of tracking open spots in the entire parking lot using cellular IoT service, such as Narrowband-IoT (NB-IoT). A sector where the kiosk is located may experience increased load at certain peak hours of operation where a huge number of UEs are looking for information about open spots in the parking lot. Other examples of CIoT can be for asset tracking, remote sensing, fitness monitoring, or various Research Electronic Data Capture (REDCap) applications that help researchers collect and manage data for studies, such as video surveillance, smart dynamic traffic management, environmental monitoring etc.

To simultaneously support multiple different services, the usable range of licensed spectrum has been sub-divided into specific spectrum bands with each one being designated for a specific service. Using this type of band structure ensures that different services are able to co-exist with each other by limiting the amount of interference that services in adjacent spectrum allocations could cause each other.

The portion used for wireless communication within the full spectrum range (3Hz-300EHz) spans from about 20 KHz to 300 GHz. Within this range, lower frequency bands like 700 MHz and 800 MHz (i.e., frequencies below 1 GHz) are crucial for providing extensive coverage and reliable connectivity as they can easily get inside buildings and walls. This makes lower frequency bands (sometimes called low-band) important for mobile and IoT device use cases in urban and rural settings as well as in any other operations requiring seamless connections, such as remote monitoring and smart agriculture. On the other hand, mid-band and high-frequency waves ranging from 2.5 GHz up to 28 GHz and 39 GHz can carry more data and provide exceptional speed for consumers and enterprises. These frequencies allow faster connection and high-speed internet access and enhance user experience on devices like 5G smartphones and tablets. Enterprises also utilize mid-band and high-frequency ranges for bandwidth-intensive applications, including virtual reality (VR) and real-time video. However, higher-frequency waves need a lot of power to travel, and they have limitations in coverage range compared to lower-frequency waves.

Conventionally, radio units (RU) coupled to the antennas are supplied with power from a power source at a cell site. With static sector configurations, each antenna serving a sector is supplied with a predetermined amount of power, which is divided between various static RF paths. With new RF paths being used for additional services, the power available per RF path decreases, resulting in a decrease of coverage area for the additional services. If power is boosted per RF path to increase the coverage area, unwanted interference plague signal clarity. Deploying additional dedicated RF paths for additional capacity or additional service causes more capital investment and cellular service downtime.

Aspects and embodiments of the present disclosure address the above and other deficiencies by dynamically adding additional frequency blocks to carry signals for newer services consumed by the UEs that are served by a specific base station (also called a cellular site, or a cell site). By enabling novel additional sector mode switch configurations, the power spectral density (PSD) can be reconfigured for the frequency blocks, allowing the cellular operators to have better radio coverage for specific services. Note that the term “frequency block” is used in the specification to refer to certain standard frequency bands that are licensed to the cellular operators. The base station (often referred to as a “gNodeB” or “gNB” in a 5G cellular network) refers to a network element responsible for the transmission and reception of radio signals to or from one or more UE while those UEs are physically within the coverage area of a particular base station. Each base station may correspond to one or more cells. Note that sometimes the term “node” is used to indicate a cell site.

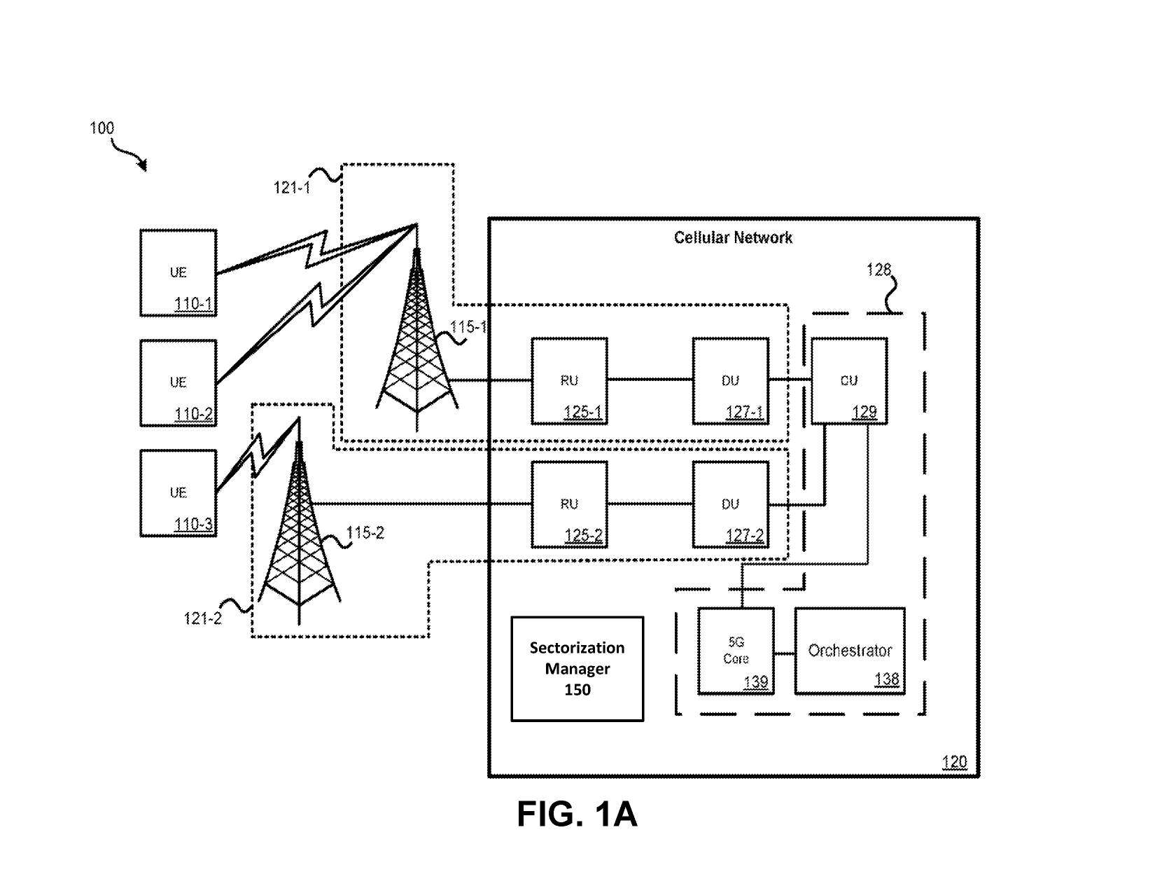

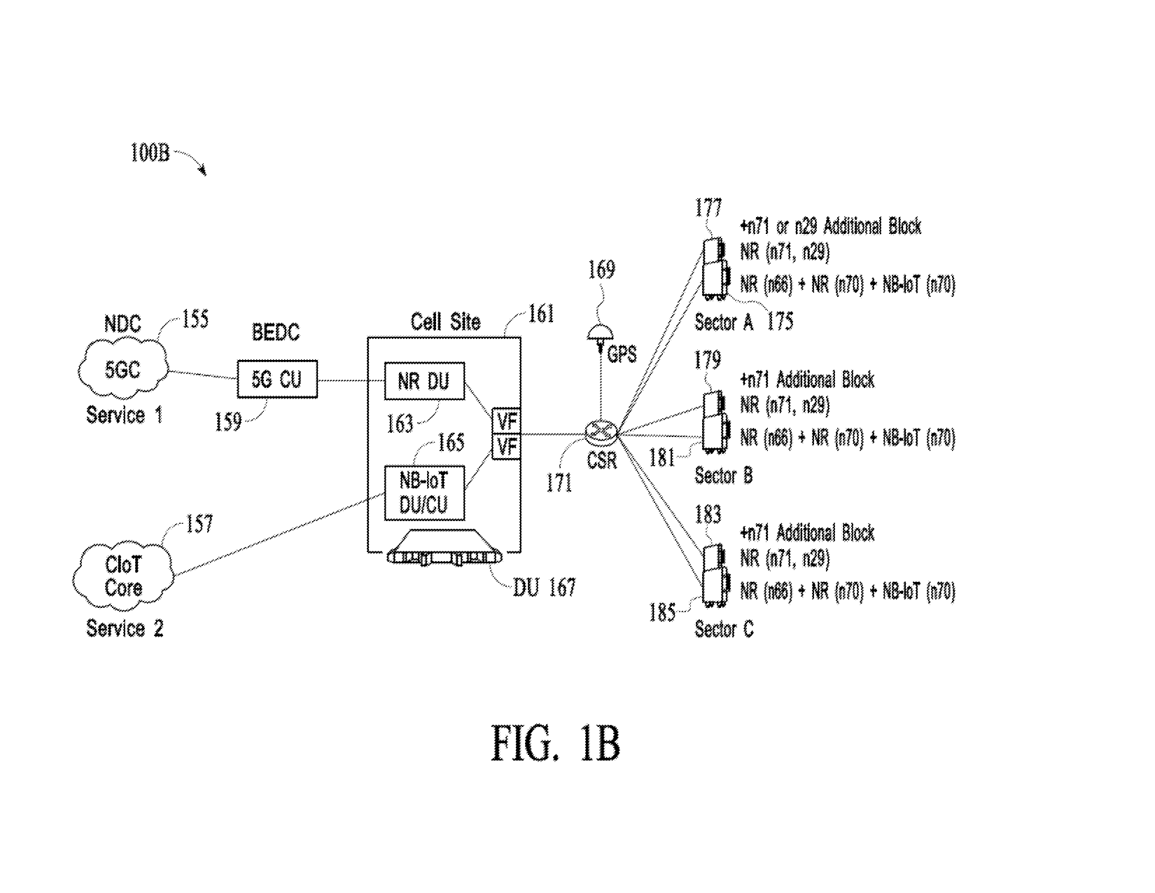

FIG. 1A illustrates an embodiment of a cellular network system 100 (“system 100”). Network system 100 can accommodate a cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU (or logical RU) or 5G core units and subunits as needed for the cellular network 120 to function properly. Kubernetes allows for container deployment, scaling, and management. As an example, if cellular traffic increases substantially in a region, an additional logical CU (or logical RU) or components of a CU (or RU) may be deployed in a data center near where the traffic is occurring without any new hardware being deployed. (Rather, processing and storage capabilities of the data center would be devoted to the needed functions.) When the need for the logical CU (or logical RU) or subcomponents of the CU (or RU) no longer exists, Kubernetes can allow for removal of the logical CU (or logical RU). Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components. Physical distribution of data centers may be implemented using a data center hierarchy that includes a local data center (LDC) that is a first electrical distance away from the cell site, a breakout edge data center (BEDC) that is a second electrical distance greater than the first electrical distance away from the cell site, and a regional data center (RDC) that is a third electrical distance greater than the second electrical distance away from the cell site.

5G core 139 may reside on a cloud computing platform. While from a client’s or user’s point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some embodiments, the cellular network 120 includes a sectorization manager 150 that implements dynamic logical sectorization for carrier power boost in a cellular network. In some embodiments, the sectorization manager 150 is part of the DU 127 (such as 127-1 or 127-2 shown in FIG. 1A). In some other embodiments, the sectorization manager 150 is part of CU 129 shown in FIG. 1A.

FIG. 1B shows a high-level architecture 100B that is specific to the operation of the sectorization manager 150 introduced in FIG. 1A. In the architecture 100B, the sectorization manager 150 would be part of a DU 167 in the cell site 161. DU 167 is equivalent to DU 127 described in FIG. 1A, but DU 167 has component 163 for supporting legacy services and component 165 for supporting newer services. A legacy service can be 5G, labeled as Service 1 in FIG. 1B. Note that 5G Core 155 shown in FIG. 1B is equivalent to 5G Core 139 described with respect to FIG. 1A. 5G core can be physically distributed across data centers, such as NDC and BEDC. In the specific example shown in FIG. 1B, the BEDC can have a 5G CU 159, while the cell site 161 has a 5G NR DU 163.

A new and additional service, i.e. Service 2 is introduced and supported by the same cellular network operator. An example of the new service (Service 2) can be CIoT that is physically distributed across CIoT core data center 157. In the example shown in FIG. 1B, the CIoT service can be handled by NB-IoT component 165, that can be a combined CU and DU for Service 2. Both the services (Service 1 and Service 2) are routed through a common cell site router (CSR) 171, that may use a global positioning system (GPS) 169 finding location of UEs and remote RUs 175, 177, 179, 181, 183 and 185.

The CSR 171 distributes the signals for various RUs that serve particular sectors. For example, RUs 175 and 177 serve Sector A, RUs 179 and 181 serve Sector B, and RUs 183 and 185 serve Sector C. In embodiments, various RUs carry various frequency bands for various services.

There are three 5G frequency bands: Low-band, Mid-band and High-band. Low-bands have greater coverage but lower speeds, Mid-bands have a balance of coverage and speed, and High-bands have higher speed but less coverage. For example, Low-band 5G can have a frequency range of 600 MHz to 700 MHz (generally less than 1GHz), and it provides coverage across a large area. But this band also has lower speeds of around 190 Mbps. Mid-band 5G can have a frequency range of 1690 MHz to 2500 MHz (1.69GHz to 2.5GHz), though generally t can be more than 1 GHz to up to 6 GHz. This band offers the highly desired balance of speed and coverage, covering large areas at speeds ranging from 100 to 900 Mbps. High-band 5G can operate at 24GHz and above, providing incredibly fast speeds ranging from 1 Gbps to 10 Gbps. But this band can only transmit data across short distances, limiting its coverage.

Users across various sectors depend on varying levels of connectivity and speed. This requires different 5G spectrum bands. To support the needs of different users, network operators use network slicing to create independent, virtual network slices from a single shared physical network. In addition, spectrum licensing limits activity on any one spectrum band to avoid interference and maximize efficiency.

The specification here uses specific mid-band frequency bands, such as n66, n70 etc, for illustrative purposes, though the scope of the disclosure is not limited to the specific examples. Both n66 and n70 are FR1 5G NR bands. Each band follows Frequency Division Duplexing (FDD) mode and the separate uplink and downlink bands allow for simultaneous transmission on two frequencies. The bands have a separation between them called the duplex spacing. 5G NR band n66 has a frequency range from 1710 - 1780 MHz (Uplink) / 2110 - 2200 MHz (Downlink) with a bandwidth of 90 MHz. 5G NR band n70 has a frequency range from 1695 - 1710 MHz (Uplink) / 1995 - 2020 MHz (Downlink) with a bandwidth of 15/25 MHz.

In certain countries, including the USA, Advanced Wireless Services (AWS) spectrum band is used for mobile voice and data services, video and messaging. Most manufacturers of smartphone mobile handsets provide versions of their phones that include radios that can communicate using the AWS spectrum. Though initially limited, device support for AWS has steadily improved the longer the band has been in general use, with most high-end and many mid-range handsets supporting it over UMTS, LTE and 5G NR. AWS has different blocks, such as AWS-1 block, sub-divided into smaller blocks A-F (covering the frequencies 1710-1755 MHz), AWS-2 block (covering the frequencies 1915-1920 MHz and 1995-2000 MHz). AWS is a set of paired bands, meaning it consists of two bands: one for UEs to transmit to base stations, and another for the base stations to transmit back to the UEs. Those two bands are 1710-1755 MHz and 2110-2155 MHz, respectively for AWS-1. Subsequent FCC auctions created AWS-3 and AWS-4. AWS-3 added four new paired blocks (G-J). AWS-4 is one large unpaired block that can be used in conjunction with other blocks (or even bands) to boost downlink (download) speeds. AWS-3 Block is sub-divided into smaller blocks G-J (covering bands 1695-1710 MHz, 1755-1780 MHz and 2155-2180 MHz), and.AWS-4 block (covering the frequencies 2000-2020 MHz and 2180-2200 MHz). An example of AWS band is n66_AWS-4. Band n66 includes AWS-1 plus AWS-3 and AWS-4.

In the example shown in FIG. 1B, RU 177 may be configured to carry n71 and n29 frequency bands for 5G New Radio (NR) services. There is enough frequency separation between the two frequency bands not to cause interference. RU 175 may be configured to carry n66 and n70 frequency bands for 5G New Radio (NR) services to sector A. A different service NB-IoT can be carried over the n70 band. With the dynamic sectorization method described in this disclosure, additional frequency blocks, such as n71 or n29 can use the same physical RF paths to carry additional signal without causing interference and signal degradation. RU 179 may be configured to carry n71 and n29 frequency bands for 5G New Radio (NR) services in sector B. RU 181 may be configured to carry n66 and n70 frequency bands for 5G New Radio (NR) services in sector B. A different service NB-IoT can be carried over the n70 band in sector B. With the dynamic sectorization method described in this disclosure, additional frequency blocks, such as n71 (or n29) can use the same physical RF paths to carry additional signal in Sector B. RU 183 maybe configured to carry n71 and n29 frequency bands for 5G New Radio (NR) services in sector B. RU 181 may be configured to carry n66 and n70 frequency bands for 5G New Radio (NR) services in sector C. A different service NB-IoT can be carried over the n70 band in sector C. With the dynamic sectorization method described in this disclosure, additional frequency blocks, such as n71 (or n29) can use the same physical RF paths to carry additional signal in Sector C.

In embodiments, having additional frequency bands available at different locations can enable flexibility in addressing capacity deficiencies at particular sectors of the various cell sites.

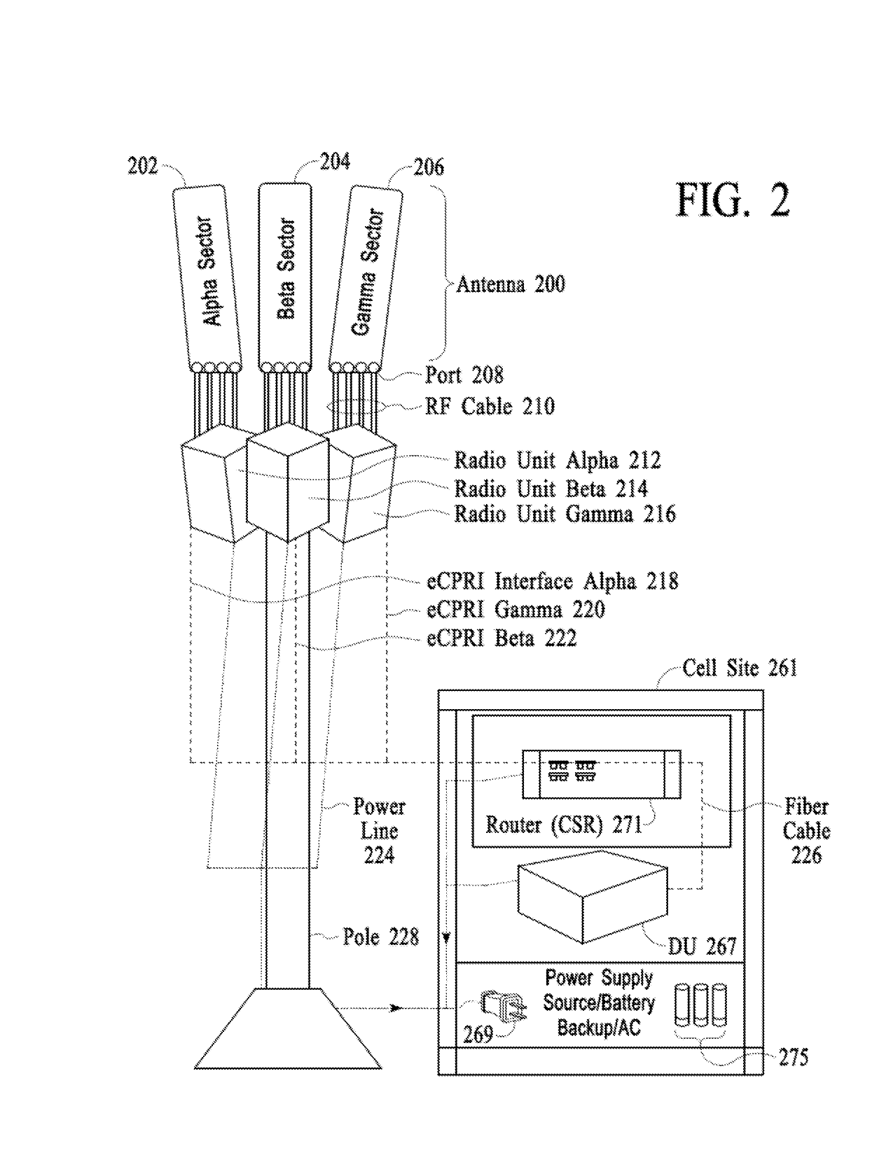

FIG. 2 illustrates a multi-sector base station’s physical structure. Multiple RUs may be mounted on a single pole 228. Each RU has a plurality of RF paths (RF cable 210) coupling the respective RU to respective a multi-port antenna 200 that serves a particular sector of the cell. Note that though three RU’s and three antennas are shown in FIG. 2 for illustrative purposes, any number of RU and corresponding antennas fall under the scope of this disclosure. Specifically in the example shown, antenna 202 serves sector Alpha. Antenna 202 has 4 ports (208), and those four ports are coupled to RU Alpha 212 through physical cables 210, creating four RF paths for sector Alpha. Similarly, antenna 204 serves sector Beta. Antenna 204 has 4 ports (208), and those four ports are coupled to RU Beta 214 through physical cables 210, creating four RF paths for sector Beta. Similarly, antenna 206 serves sector Gamma. Antenna 206 has 4 ports (208), and those four ports are coupled to RU Gamma 216 through physical cables 210, creating four RF paths for sector Gamma. Note that the sectors Alpha, Beta, Gamma can be similar to sectors A, B, and C shown in FIG. 1B, just different nomenclature is used.

A cell cite 261 (similar to cell site 161 in FIG. 1B) houses a DU 267 (similar to DU 167 in FIG. 1B) and a router 271 (similar to CSR 171), and also provides power to the RUs and the antenna 200 via power line 224 (shown as dotted line). The power to the RUs is supplied through an electric plug 269 connected to an electric outlet (not shown) and/or from a battery pack 275. The battery pack 275 can provide redundancy and/or acts as backup in case of power grid outage. Also, since power supply to each RU may need to be boosted as needed (described below), the battery pack 275 can supplement baseline power per RF path by providing additional power as required. The cell site 261 also connects DU 267 with the RUs 212, 214, 216 using fiber cable 226 suitable for fiber-based interface. One such interface is called the enhanced Common Public Radio (eCPRI) interface, as shown as non-limiting example in FIG. 2. Each RU 212, 214 and 216 has their own eCPRI interface with DU 267.

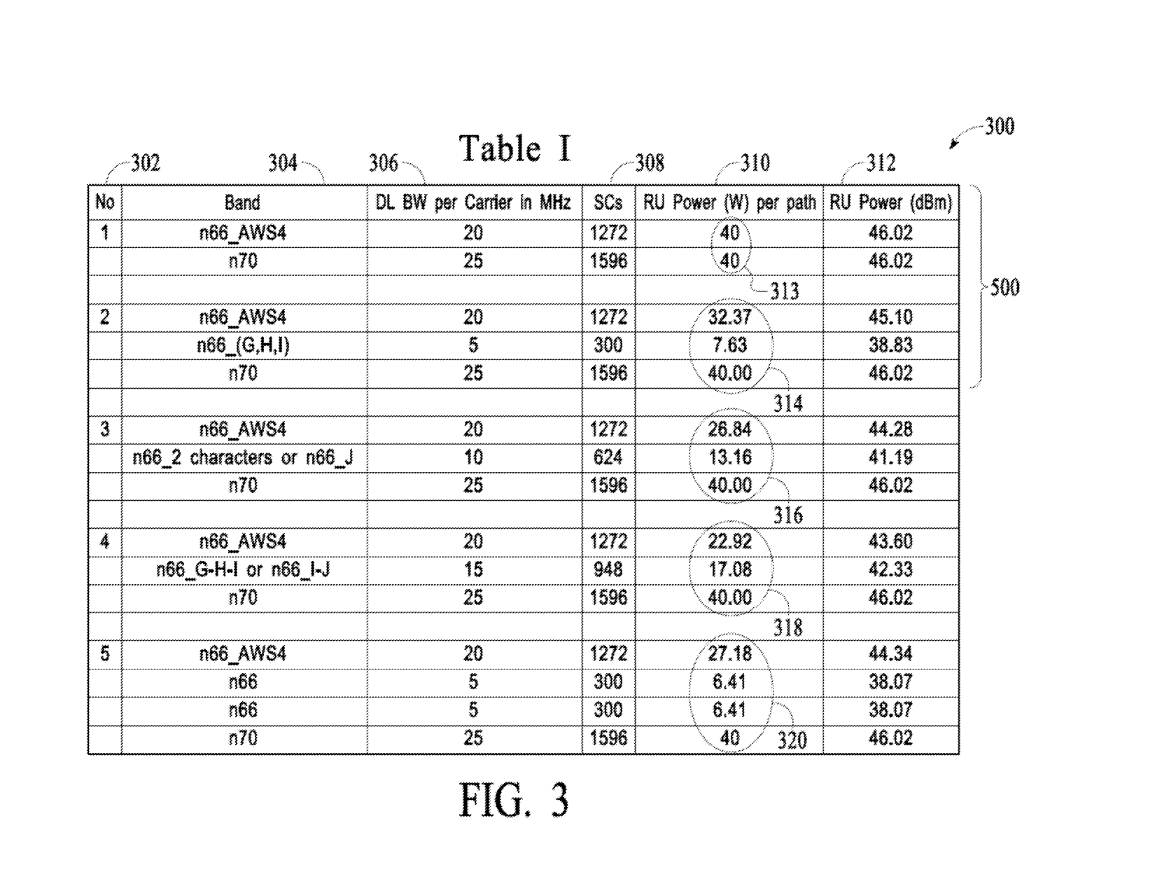

A cell can be divided into multiple geographic sectors by installing and orienting the antennas appropriately. FIGS. 3-7 describe the operations within each sector of a cell. For example, Tables I, II and III may be associated with either of Sector Alpha, Sector Beta or Sector Gamma shown in FIG. 2. Initially each RU is deployed with one or more default configuration having a plurality of radio frequency (RF) paths coupling the RU to a multi-port antenna that serves a particular sector of the cell.

FIG. 3 shows a non-limiting example Table I (300) which lists various configurations (column 302) of an RU connected to a multi-port antenna acting in a 4T4R mode. In the 4T4R default configuration, there are four possible transmit RF paths and four possible receive RF paths. Other configurations are possible too, such as 2T2R, 8T8R etc. Note that though each antenna, such as antenna 202, can support up to four RF paths, as there are four ports to be configured and four physical RF cables 210 going to the ports, not all settings use all four RF paths. Also, a same physical cable can be used as a transmit RF path and a receive RF path, though the frequency bands used for uplink and downlink may be different. In the column 302, the default configuration is Configuration 1, where only two frequency bands are used. This disclosure proposes dynamically reconfiguring the RU to many other possible configurations, as shown in Confugurations 2, 3, 4 and 5 along column 302.

In Table I, column 304 lists the carrier frequency bands (or frequency blocks) used to transmit/receive signal for various configurations 302, column 306 lists Downlink (DL) bandwidth (BW) per carrier in Megahertz (MHz), column 308 lists the subcarriers in MHz (a secondary signal that is modulated into a main carrier frequency to create an additional channel for transmission), column 310 lists RU power in watts (W) per RF path, and column 312 lists the RU power converted to decibel-milliwatts (dBm, which is a unit of power level expressed using a logarithmic decibel (dB) scale respective to one milliwatt (mW)).

As seen in the column 310 of Table I, when just two RF paths are being used, the power spectral density (PSD) calculations show that each RF path can transmit/receive 40W of power without causing unwanted interference as the two carrier frequency bands n66_AWS4 and n70 have enough spectral separation. This is the default configuration. This is shown within the outline 313. However, when more bands within n66 are added for an alternative configuration (configuration 2) that can carry signals for additional services, the total power carried by the n66 band is sub-divided into less power per path without additional power boost from the cell site. For example, if the total power is 40 W for n66, them as shown in outline 314, n66_AWS4 carries 32.37 W of power, and n66_ (G, H, or I) carries 7.63W of power, totaling 40 watts for all the n66 bands combined. N70 can carry the entire 40 watts (unchanged from configuration 1). The similar division of power allocated for n66 band can be seen for the other configurations also, as shown within the outlines 316, 318 and 320. With power per path getting reduced, the coverage area within a sector also gets reduced. Therefore, it is needed to boost power in the various n66 bands not to compromise the coverage area. Note that the specific frequency bands and other numerical values shown in the Tables I, II, and III are for illustrative purposes only and the scope of the disclosure is not limited by those numbers.

Current software packages run at a DU support only a fixed configuration (such as 4T4R configuration) in both Low-Band and Mid-Band RU. The software restricts an operator from reconfiguring the fixed configuration, because the platform is hardcoded to support only the specific fixed configuration. For example, an operator cannot reconfigure 4T4R to 2T2R or 2T4R manually, as the RU is hardcoded to support only 4T4R.

This disclosure proposes a solution by installing a software package in DU 267 to support “split sector” in an RU (such as RU 212). “Split sector” refers to a logical sectorization (i.e. dividing a sector logically into sub-sectors) in a dynamic way as load conditions change. With split sector, various RF paths for frequency bands used to carry signals for various services do not suffer from low power that affect the coverage area. For example, 4T4R can be reconfigured as Bi-Sector 2T2R within both DU and RU along with additional support where number of ports in a transmission/receive antenna remain the same. The splitting can be done by sectorization manager 150 being executed at a DU or in some other embodiments, being executed at a CU.

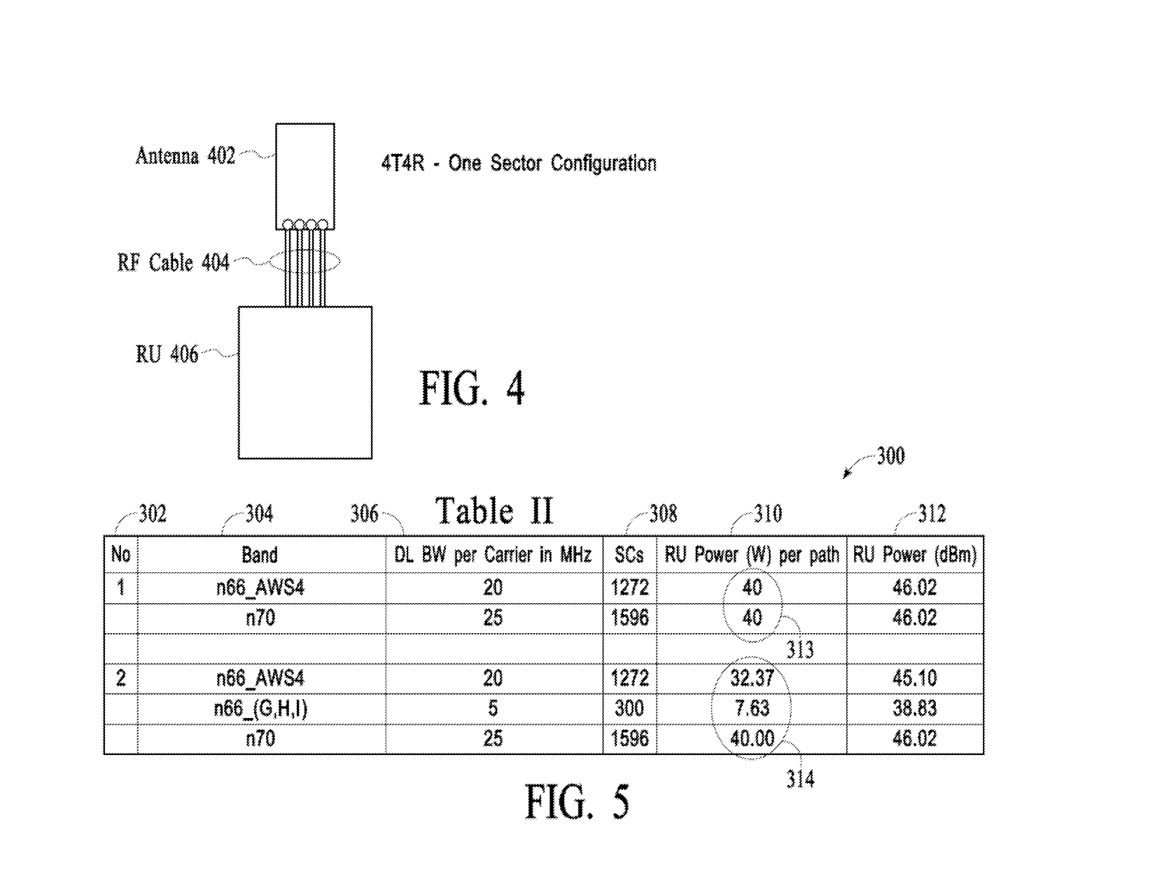

FIG. 4 shows an RU 406 and an antenna 402 working in a 4T4R default configuration to statically support one sector. The RF cables 404 indicate the four possible RF paths. Note that not all RF paths need to be utilized in all configurations.

FIG. 5 shows Table II, which is a truncated part 500 of Table I shown in FIG. 3. For simplicity, let’s assume the RU 406 has a default configuration—configuration 1 (column 302) and can be dynamically reconfigured to configuration 2 (column 302). An additional n66 band is added in the reconfigured RU to carry additional signals. As described with respect to Table I, the RU power per RF path for n66_AWS4 and n66_(G, H, I) bands is reduced, as the total power for n66 is allocated to be 40W.

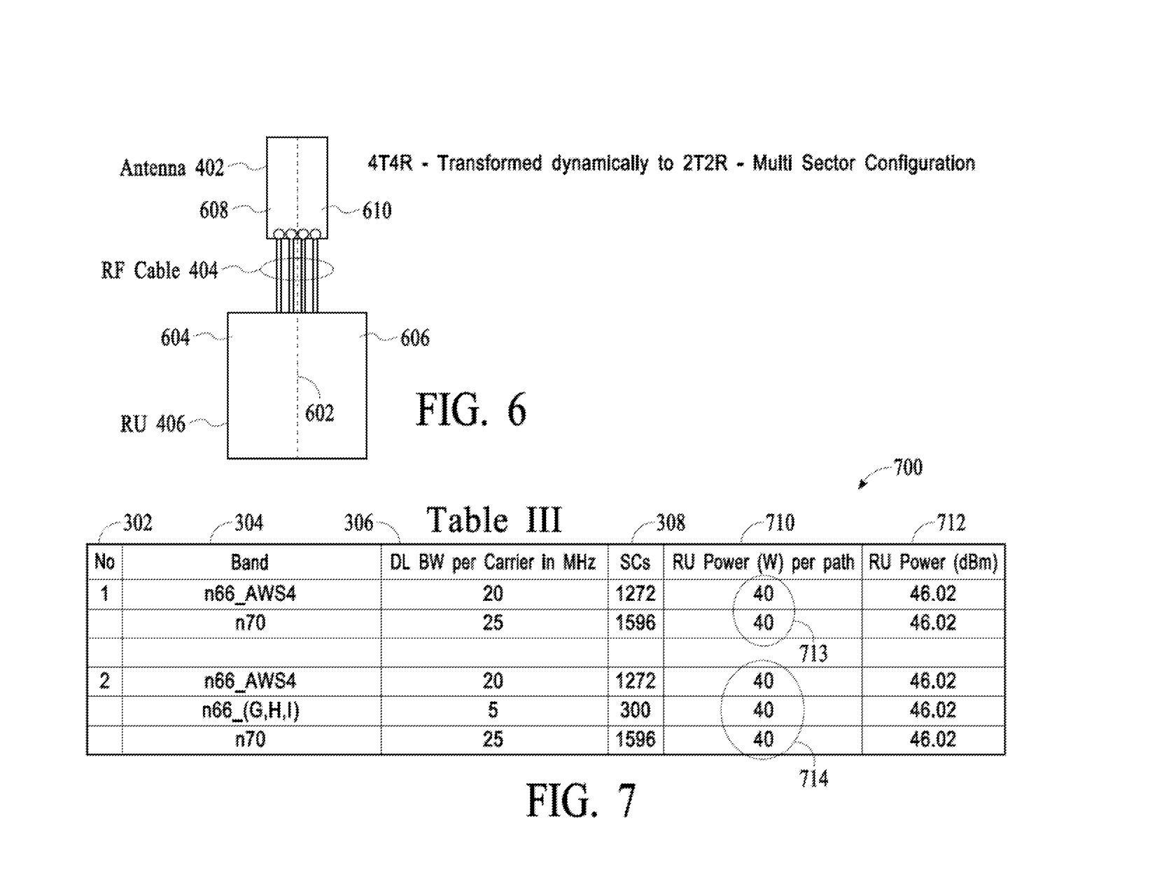

FIG. 6 shows an RU 406 and an antenna 402 programmed in a 4T4R default configuration to dynamically support “split sector” within the previously supported sector, according to embodiments of the present disclosure. In this example, the previous 4T4R configuration is transformed dynamically to two 2T2R logical sub-sectors, which are shown separated by the virtual dashed line 602, though no physical hardware change is implemented. With the logical sectorization, the RU sub-sector 604 is coupled to the antenna sub-sector 608, and the RU sub-sector 606 is coupled to the antenna sub-sector 610.

FIG. 7 shows Table III (700), which is to be compared with Table II. Though from the hardware perspective, the logically sectorized system shown in FIG. 6 has the same configurations—configuration 1 and configuration 2 (column 302), the RU power per RF path for n66_AWS4 and n66_(G, H, I) bands is no longer reduced, as the total power for n66 is boosted so that each of the n66 bands now carry 40 Watts, as shown within outline 714. With the power boost, coverage area is not reduced, however, the number of antenna ports is now two (2T2R) instead of four antenna ports (4T4R), as the logical sub-sector is now 2T2R after reconfiguration. Now the n66(G or H or I Block) with 5MHz downlink bandwidth is part of RU sub-sector 606 and antenna sub-sector 610 with 40W per path.

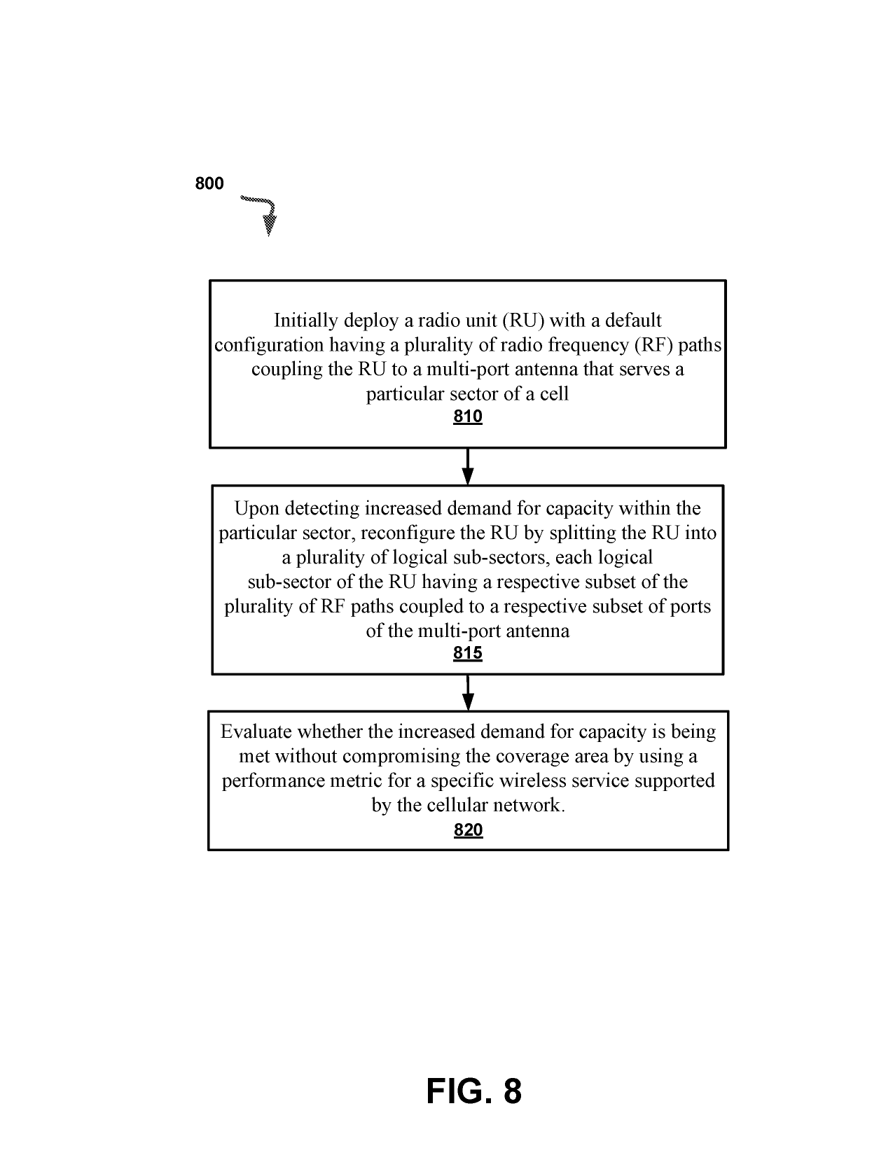

Note that instead of boosting the power in the existing frequency bands, in some embodiments, and additional frequency band can be added in one of the logical sub-sectors to carry additional service. For example, as shown in FIG. 1B, a new frequency band n71 or n29 can be added to a logical sub-sector. This is described in greater detail with respect to method 800 in FIG. 8.

Note that instead of 4T4R, the original default configuration maybe 8T8R, which can be logically subdivided into four 2T2R logical sub-sectors, or, two 4T4R logical sub-sectors, or two 2T2R logical sub-sectors and one 4T4R logical sub-sector.

In some implementations, a system (e.g., system 100 in FIG. 1A) may include a computing system, such as the sectorization manager 150, to facilitate a cellular network (e.g., the cellular network 120 in FIG. 1A) accomplish the functionalities described above. The computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), a computing device in a data center, or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1A), may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a sectorization manager 150.

FIG. 8 is a flow diagram of a method 800 of dynamic reconfiguration scheme in a cellular network according to an embodiment. The method 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 800 is performed by the components of the system 100 of FIG. 1A. In one various embodiment, the method 800 is performed by the sectorization manager 150.

At operation 810, a processing logic in the sectorization manager 150 initially deploys an RU with a default configuration having a plurality of RF paths coupling the RU to a multi-port antenna that serves a particular sector of a cell.

At operation 815, the processing logic in the sectorization manager detects increased demand for capacity within the particular sector that requires assigning additional frequency bands. As a first step for addressing the increased demand, the processing logic in the sectorization manager reconfigures the RU by splitting the RU into a plurality of logical sub-sectors, each logical sub-sector of the RU having a respective subset of the plurality of RF paths coupled to a respective subset of ports of the multi-port antenna.

The reconfiguration process involves adding a respective new spectrum block to existing spectrum blocks in one or more of the RF paths in at least one of the logical sub-sectors such that a transmit power of the reconfigured RU meets the increased demand for capacity without compromising coverage within the particular sector.

In embodiments, the new spectrum block belongs to the low-band or mid-band of frequency spectrum, though high-band spectrum block can also be added depending on the power requirement.

Addition of the new spectrum block is based on calculating PSD for the existing and added spectrum blocks in the one or more RF paths. Note that two different RF paths can share the same physical RF cable, as long as the Power Spectral Density (PSD) calculations indicate that the various frequency bands are not interfering with each other leading to signal degradation.

At operation 820, the processing logic in the sectorization manager evaluates whether the increased demand for capacity is being met without compromising the coverage area by using a performance metric for a specific wireless service supported by the cellular network. Examples for the specific wireless service can be CIoT, 5G NR etc., as discussed above. In some embodiments, the performance metric comprises Maximum Allowable Path Loss (MAPL). MAPL represents the maximum amount of attenuation (signal loss) that a radio signal can experience during transmission while still maintaining an acceptable level of signal quality. The solution proposed herein maintains an acceptable MAPL without deploying new base stations with new antennas. Rather power in the logical sub-sector of the existing antenna is boosted to maintain MAPL or reduce loss.

In summary, impact of the dynamic reconfiguration is that adding the additional frequency block and boosting power for the additional frequency block ensures that RF coverage footprint remains comparable to the default configuration or becomes better, as measured by the relevant performance metric. Though the number of RF paths per sub-sector reduces when 4T4R is reconfigured into two 2T2R sub-sectors, each sub-sector gets enough power boost to not compromise coverage area. Therefore, the dynamic reconfiguration increases user capacity, sector capacity and RF footprint efficiently. In an illustrative example, NB-IoT carrier power can be increased from 36.3 dBm to 46 dBm, which is a 9dB PSD increase, which is approximately 8 times the default power configuration enabling much father coverage gain.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose or special-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamically reconfiguring a radio unit (RU) coupled to a cellular site of a cellular network, the method comprising:
initially deploying the RU with a default configuration having a plurality of radio frequency (RF) paths coupling the RU to a multi-port antenna that serves a particular sector of a cell; and
upon detecting increased demand for capacity within the particular sector, reconfiguring the RU by splitting the RU into a plurality of logical sub-sectors, each logical sub-sector of the RU having a respective subset of the plurality of RF paths coupled to a respective subset of ports of the multi-port antenna.

2. The method of claim 1, wherein the reconfiguring the RU further comprises:
adding a respective new spectrum block to existing spectrum blocks in one or more of the RF paths in at least one of the logical sub-sectors such that a transmit power of the reconfigured RU meets the increased demand for capacity without compromising coverage within the particular sector.

3. The method of claim 2, wherein the new spectrum block belongs to the low-band of frequency spectrum below 1GHz or mid-band of frequency spectrum from 1 GHz to 6 GHz.

4. The method of claim 2, further comprising:
calculating power spectral density (PSD) for the existing and added spectrum blocks in the one or more RF paths.

5. The method of claim 4, further comprising:
evaluating whether the increased demand for capacity is being met without compromising the coverage area by using a performance metric for a specific wireless service supported by the cellular network.

6. The method of claim 5, wherein the performance metric comprises Maximum Allowable Path Loss (MAPL).

7. The method of claim 5, wherein the new spectrum block is associated with a new wireless service.

8. The method of claim 1, wherein the default configuration for the RU is 4T4R.

9. The method of claim 8, wherein a sectorization manager splits the reconfigured RU into two 2T2R logical sub-sectors.

10. The method of claim 1, wherein the default configuration for the RU is 8T8R.

11. The method of claim 10, wherein a sectorization manager splits the reconfigured RU into a plurality of logical sub-sectors in one of the following ways: two 4T4R logical sub-sectors, four 2T2R logical sub-sectors, or, one 4T4R and two 2T2R logical sub-sectors.

12. A system to facilitate dynamically reconfiguring a radio unit (RU) coupled to a cellular site of a cellular network, the system comprising:
one or more processing devices; and
memory communicatively coupled with and readable by the one or more processing devices and having stored therein processor-readable instructions which, when executed by the one or more processing devices, cause the one or more processing devices to perform operations comprising:
initially deploying the RU with a default configuration having a plurality of radio frequency (RF) paths coupling the RU to a multi-port antenna that serves a particular sector of a cell; and
upon detecting increased demand for capacity within the particular sector, reconfiguring the RU by splitting the RU into a plurality of logical sub-sectors, each logical sub-sector of the RU having a respective subset of the plurality of RF paths coupled to a respective subset of ports of the multi-port antenna.

13. The system of claim 12, wherein the operation of reconfiguring the RU further comprises:
adding, by the processing device, a respective new spectrum block to existing spectrum blocks in one or more of the RF paths in at least one of the logical sub-sectors such that a transmit power of the reconfigured RU meets the increased demand for capacity without compromising coverage within the particular sector.

14. The system of claim 13, wherein the operation further comprises:
calculating, by the processing device, power spectral density (PSD) for the existing and added spectrum blocks in the one or more RF paths.

15. The system of claim 14, wherein the operation further comprises:
evaluating, by the processing device, whether the increased demand for capacity is being met without compromising the coverage area by using a performance metric for a specific wireless service supported by the cellular network.

16. The system of claim 15, wherein the performance metric comprises Maximum Allowable Path Loss (MAPL).

17. The system of claim 13, wherein the default configuration for the RU is 4T4R, and wherein a sectorization manager splits the reconfigured RU into two 2T2R logical sub-sectors.

18. The system of claim 13, wherein the default configuration for the RU is 8T8R, and wherein a sectorization manager splits the reconfigured RU into a plurality of logical sub-sectors in one of the following ways: two 4T4R logical sub-sectors, four 2T2R logical sub-sectors, or, one 4T4R and two 2T2R logical sub-sectors.

19. One or more non-transitory, computer-readable storage media having computer-readable instructions thereon which, when executed by one or more processing devices, cause the one or more processing devices to perform operations to facilitate dynamically reconfiguring a radio unit (RU) coupled to a cellular site of a cellular network, the operations comprising:
initially deploying the RU with a default configuration having a plurality of radio frequency (RF) paths coupling the RU to a multi-port antenna that is serving a particular sector of a cell; and
upon detecting increased demand for capacity within the particular sector, reconfiguring the RU by splitting the RU into a plurality of logical sub-sectors, each logical sub-sector of the RU having a respective subset of the plurality of RF paths coupled to a respective subset of ports of the multi-port antenna.

20. The one or more non-transitory computer-readable storage media of claim 19, wherein the operations further comprise:
adding, by the processing device, a respective new spectrum block to existing spectrum blocks in one or more of the RF paths in at least one of the logical sub-sectors such that a transmit power of the reconfigured RU meets the increased demand for capacity without compromising coverage within the particular sector.
